(19) United States
(12) Patent Application Publication
(10) Pub. No.: US 2009/0145212 A1
(43) Pub. Date: Jun. 11, 2009

(54) Sensor with quick connector

(75) Inventor: Patrick Powell, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 11/999,711

(22) Filed: Dec. 6, 2007

(51) Int. Cl. G01M 15/09

(52) U.S. Cl. 73/114.73; 123/445

(57) ABSTRACT

A fuel injection system includes a fuel tank, a supply line, a fuel injection rail and a number of fuel injectors. The fuel tank includes a fuel tank module which houses a fuel pump. The fuel pressure within the fuel injection system is monitored by a pressure sensor which is integrated into a quick connector between the fuel supply line and the fuel tank module.

### FIELD

The present disclosure relates to a sensor that is integrated into a quick connector. More particularly, the present disclosure relates to a pressure sensor integrated into the quick connector for a fuel line in an automobile.

### BACKGROUND

The statements in this section merely provide background information related to the present disclosure and may not constitute prior art.

Conventional fuel injection systems include a fuel tank with a fuel delivery module including a fuel pump attached to the fuel tank, a fuel filter, a pressure regulation system, a fuel rail, fuel injectors and fluid lines interconnecting the various components. Fuel injection systems can include return systems where the fuel is continuously circulated from the fuel tank to the fuel rail and then returned to the fuel tank or fuel injection systems can be designed as returnless systems where fuel is supplied to the fuel rail without a return line to the fuel tank. In both systems, the pressure in the fuel system is maintained at a specified pressure.

The returnless fuel systems can be either a mechanical returnless fuel system (MRFS) or an electronic returnless fuel system (ERFS). In the MRFS a spring loaded mechanical regulator is utilized to regulate the pressure of the fuel system. ERFS does not utilize a mechanical regulator for regulating the pressure of the fuel system but instead, the fuel system varies the voltage to the fuel pump to raise and lower the fuel system pressure based upon engine demand. Thus, the current pressure of the fuel system needs to be monitored and fed back to the control system of the fuel injection system.

Fuel line pressure sensors are known in the art and they can be placed anywhere along the fuel line to monitor the system pressure. It has been found to be desirable to locate the fuel pressure sensor in the rear of the vehicle close to the fuel pump because the pressure pulsations near the fuel pump are lower than other locations in the fuel line.

### SUMMARY

The present disclosure provides a pressure sensor integral with the quick connector of the fuel system. The fuel delivery module includes an outlet port which is designed to be connected to the fuel line using a quick connector to simplify assembly of the vehicle. The integration of the pressure sensor with the quick connector eliminates additional assembly of the fuel system other than connecting the wire harness to the quick connector/fuel pressure sensor combination and it locates the pressure sensor at a position near the fuel pump which is part of the fuel delivery module.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side view of an automobile incorporating the fuel injection system according to the present disclosure;

FIG. 2 is a schematic view of the fuel injection system according to the present disclosure;

FIG. 3 is a perspective view of the fuel tank illustrated in FIGS. 1 and 2;

FIG. 4 is a perspective exploded view of the fuel tank module and the fuel supply line illustrated in FIGS. 1 and 2 with the fuel line and quick connector; and

FIG. 5 is an enlarged side view of the quick connector and pressure sensor in accordance with the present disclosure.

### DETAILED DESCRIPTION

The following description is merely exemplary in nature and is not intended to limit the present disclosure, application, or uses.

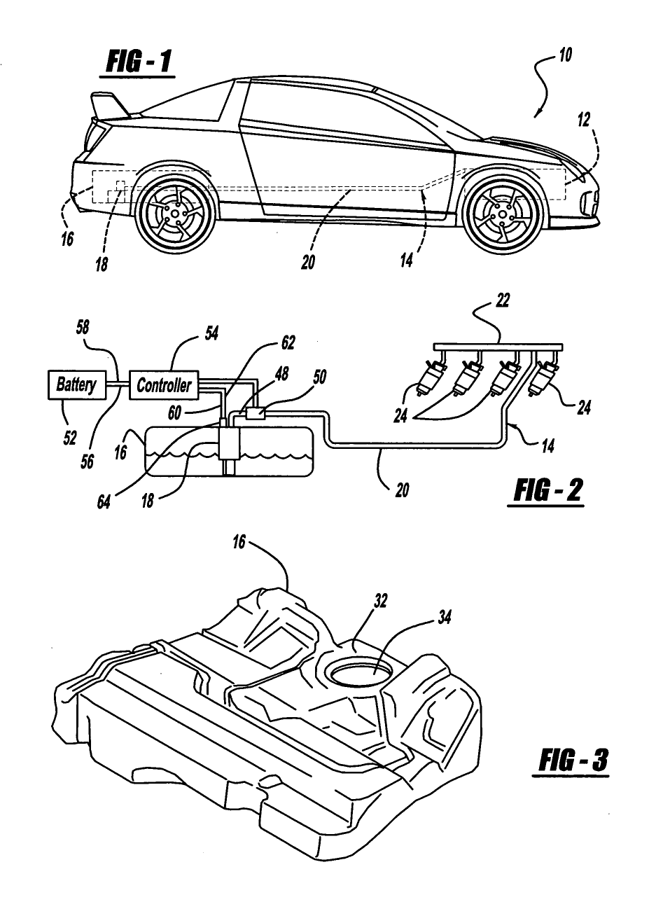

FIGS. 1 and 2 illustrate a vehicle 10, such as an automobile, having an engine 12 and a fuel injection system 14. Fuel injection system 14 comprises a fuel tank 16, a fuel tank module 18, a fuel supply line 20, a fuel injector rail 22 and a plurality of fuel injectors 24.

Fuel tank 16 is typically located in the rear of vehicle 10 with fuel tank module 18 being located within fuel tank 16. Fuel supply line 20 extends from fuel tank module 18 to fuel injector rail 22 which is typically located on or near engine 12 located in the front of vehicle 10. Each fuel injector 24 is in communication with fuel injector rail 22 to receive fuel which is then injected into one of the cylinders of engine 12.

Fuel injection system 14 does not have a fuel return line from fuel injector rail 22 to fuel tank 16. Because of this, a fuel pump 30 within fuel tank module 18 has its voltage varied to adjust the amount of fuel supplied to fuel injector rail 22 to maintain a specified fuel pressure within fuel injection system 14 as is dictated by the fuel demand from engine 12.

FIG. 3 is a perspective view of fuel tank 16 depicting a mounting location 32 for fuel tank module 18 such as the structure surrounding a hole 34 in the top of fuel tank 16. Typically, fuel tank module 18 with fuel pump 30 is lowered through hole 34 of fuel tank 16 and then secured to mounting location 32.

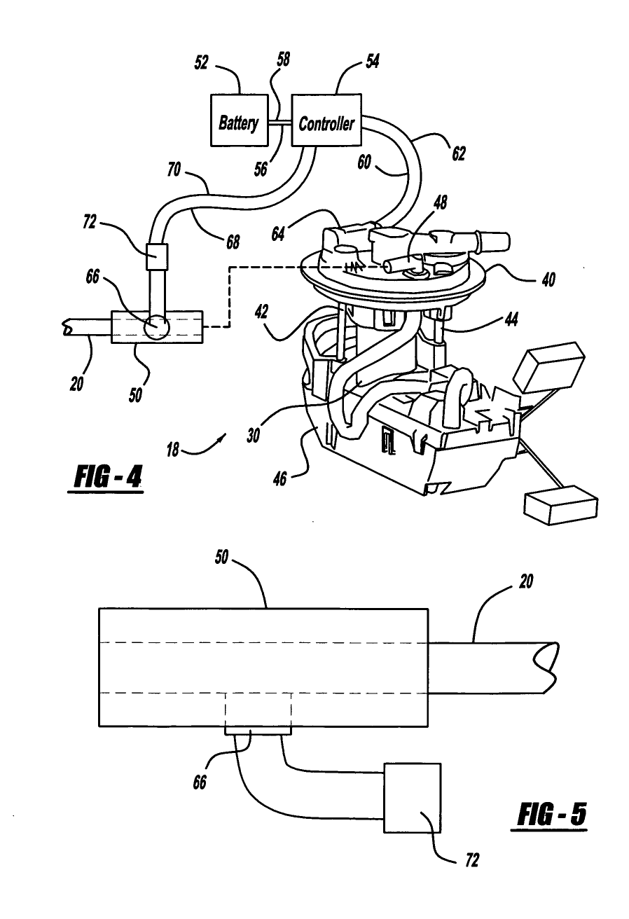

Referring to FIG. 4, fuel tank module 18 includes a flange 40 that mounts to mounting location 32 of fuel tank 16. Flange 40 forms a seal, such as with an O-ring, with mounting location 32 when fuel tank module 18 is secured to fuel tank 16. First and second reservoir rods 42, 44 position a fuel reservoir 46 at the bottom interior wall of fuel tank 16. From the top of flange 40, an engine fuel line male connector 48 protrudes to deliver fuel to fuel supply line 20 and eventually to engine 12 through fuel injector rail 22 and fuel injectors 24. During the assembly of vehicle 10, fuel supply line 20 is connected to connector 48 using a quick connector 50 which is assembled to one end of fuel supply line 20. Quick connector 50 is designed to sealingly mate with connector 48 such that fuel tank module 18 is in fluid communication with fuel supply line 20 for supplying fuel from fuel tank 16 to engine 12.

Referring now to FIGS. 2 and 5, fuel injection system 14 is powered by a vehicle battery 52 through a fuel pump control module 54. Electrical power lines 56, 58 extend between vehicle battery 52 and fuel pump control module 54 and electrical power lines 60, 62 extend between fuel pump control module 54 and fuel tank module 18 with fuel pump 30. A connector 64 as shown in FIG. 4 is utilized to connect power lines 60 and 62 to fuel tank module 18. Fuel pump control module 54 controls the pressure of fuel within fuel injection system 14 by varying the voltage supplied to fuel pump 30 through power lines 60, 62. A pressure sensor 66 is in communication with fuel pump control module 54 through control lines 68 and 70. Pressure sensor 66 is attached to control lines 68 and 70 using a connector 72. Pressure sensor 66 continuously monitors the fuel pressure created by fuel pump 30. Fuel pump control module 54 continuously monitors this fuel pressure to vary the voltage to fuel pump 30 such that the fuel pressure within fuel injection system 14 is maintained at a specified value.

Pressure sensor 66 is integrated into quick connector 50 to simplify the design and assembly of fuel injection system 14 into vehicle 10. When quick connector 50 with pressure sensor 66 is connected to connector 64 on fuel tank module 18, all that is needed is to connect control lines 68 and 70 to connector 72 and connect power lines 60 and 62 to connector 64. This places pressure sensor 66 close to fuel pump 30 which is the desired position for pressure sensor 66 because of the reduced pressure pulsations of fuel injection system 14 near fuel pump 30.

Thus, fuel supply line 20 with connector 50 and internal pressure sensor 66, fuel tank module 18 with connector 48 and fuel pump control module 54 define a fluid pressure monitoring system which simplifies the assembly of the system into vehicle 10 and positions pressure sensor 66 at the desired location.

While quick connector 50 with pressure sensor 66 is illustrated as being assembled to fuel supply line 20 and connector 48 is illustrated as being attached to fuel tank module 18, it is within the scope of the present disclosure to have quick connector 50 with pressure sensor 66 attached to fuel tank module 18 and to have connector 48 be a part of fuel supply line 20.

1. A fluid pressure monitoring system comprising:
a vehicle having an engine with a fuel injection system and a fuel tank;
a fuel tank module having a fuel pump under a top of said module and a first connector protruding from a top of said fuel tank module;
a second connector attached to said first connector, wherein said second connector is a quick connector and connects with said first connector, said first and second connectors part of said fuel injection system;
a pressure sensor secured to said second connector; and
a control module in communication with said pressure sensor and said fuel pump, said control module for monitoring a fuel pressure to vary a voltage to said fuel pump to maintain fuel pressure within said fuel injection system.

2. The fluid pressure monitoring system according to claim 1, wherein said first and second connectors are part of said fuel injection system.

3. The fluid pressure monitoring system according to claim 2, wherein said first connector is attached to said fuel tank module of the fuel injection system.

4. The fluid pressure monitoring system according to claim 3, wherein said second connector is attached to a fuel supply line of said fuel injection system.

5-8. (canceled)

9. The fluid pressure monitoring system according to claim 4, wherein said control module being in communication with said fuel pump to control fluid pressure within said first and second connectors.

10. (canceled)

11. The fluid pressure monitoring system according to claim 2, wherein said fuel injection system includes a fuel supply line, a fuel injector rail and a plurality of fuel injectors.

12-17. (canceled)

18. A fluid pressure monitoring system comprising:
a vehicle having an engine with a fuel injection system and a fuel tank;
a fuel tank module having a fuel pump under a top of said module and a first connector protruding from a top of said fuel tank module, said fuel tank module located within said fuel tank;
a second connector attached to said first connector, wherein said second connector is a quick connector and connects with said first connector, said first and second connectors part of said fuel injection system;
a pressure sensor secured to said second connector; and
a control module in communication with said pressure sensor and said fuel pump, said control module for monitoring a fuel pressure to vary a voltage to said fuel pump to maintain fuel pressure within said fuel injection system and to control fluid pressure within said first and second connectors, wherein said fuel injection system includes a fuel supply line, a fuel injector rail and a plurality of fuel injectors.

19. The fluid pressure monitoring system according to claim 18, wherein said control module is in communication with said fuel pump to control fluid pressure within said first and second connectors by varying a fuel pump voltage.

20. The fluid pressure monitoring system according to claim 19, wherein said fuel injection system includes a fuel supply line, a fuel injector rail and a plurality of fuel injectors.
